(19) United States
(12) Patent Application Publication
(10) Pub. No.: US 2024/0274885 A1
(43) Pub. Date: Aug. 15, 2024

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si, Gyeonggi-do (KR)

(72) Inventors: Sujeong KOH, Yongin-si (KR); Jinah SEO, Yongin-si (KR); Jin-Hyeok LIM, Yongin-si (KR); Erang CHO, Yongin-si (KR); Yunhee KIM, Yongin-si (KR)

(21) Appl. No.: 18/482,641

(22) Filed: Oct. 6, 2023

(30) Foreign Application Priority Data
Feb. 8, 2023 (KR) 10-2023-0016933

(51) Int. Cl. H01M 10/0568; H01M 4/02; H01M 4/133; H01M 4/36; H01M 4/587; H01M 10/052; H01M 10/0569; H01M 10/42

(52) U.S. Cl. CPC H01M 10/0568; H01M 4/133; H01M 4/366; H01M 4/587; H01M 10/052; H01M 10/0569; H01M 10/4235; H01M 2004/021; H01M 2004/027; H01M 2300/0037

(57) ABSTRACT

An electrolyte for a rechargeable lithium battery and rechargeable lithium battery including the same, the electrolyte including a non-aqueous organic solvent, a lithium salt, and a sodium imide salt. Details of the sodium imide salt are as described in the specification.

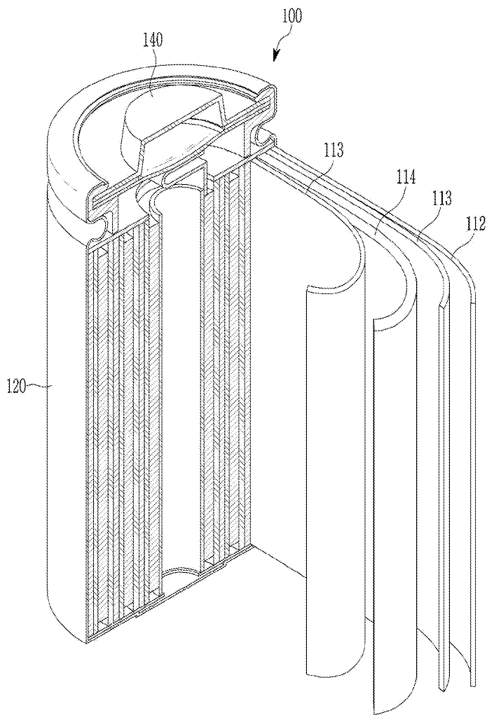

### CROSS-REFERENCE TO RELATED APPLICATION

This application claims priority to and the benefit of Korean Patent Application No. 10-2023-0016933, filed in the Korean Intellectual Property Office on Feb. 8, 2023, the entire content of which is incorporated herein by reference.

### BACKGROUND

### 1. Field

Embodiments of the present disclosure described herein are related to an electrolyte for a rechargeable lithium battery and a rechargeable lithium battery including the same.

### 2. Description of the Related Art

A rechargeable lithium battery may be recharged and has three or more times higher energy density per unit weight than a comparable lead storage battery, nickel-cadmium battery, nickel hydrogen battery, nickel zinc battery and/or the like, and may also be highly charged and thus, is commercially manufactured for a laptop, a cell phone, an electric tool, an electric bike, and/or the like, and researches on improvement of additional energy density have been actively made.

Such a rechargeable lithium battery is manufactured by injecting an electrolyte into a battery cell, which includes a positive electrode including a positive electrode active material capable of intercalating/deintercalating lithium ions and a negative electrode including a negative electrode active material capable of intercalating/deintercalating lithium ions.

One of the recent development directions of the rechargeable lithium battery is rapid charging. However, if the rechargeable lithium battery is rapidly charged, lithium dendrite is precipitated on the negative electrode surface (for example, on the interface of the negative electrode and the electrolyte), causing problems of deteriorating cycle-life (life cycle) characteristics and/or increasing resistance of the rechargeable lithium battery.

Accordingly, there is a desire for an electrolyte capable of improving rapid charging performance as well as minimizing or reducing the deterioration of cycle-life characteristics and/or the resistance increase of the rechargeable lithium battery.

### SUMMARY

An aspect according to one or more embodiments is directed toward an electrolyte for a rechargeable lithium battery that improves rapid charging performance while minimizing or reducing deterioration of cycle-life characteristics and/or increase in resistance.

An aspect according to one or more embodiments is directed toward a rechargeable lithium battery with improved rapid charging performance while minimizing or reducing deterioration of cycle-life characteristics and/or increase in resistance by applying the electrolyte for a rechargeable lithium battery.

Additional aspects will be set forth in part in the description which follows and, in part, will be apparent from the description, or may be learned by practice of the presented embodiments of the disclosure.

Embodiments of the present disclosure provides an electrolyte for a rechargeable lithium battery including a non-aqueous organic solvent, a lithium salt, and a sodium imide salt, wherein a content (e.g., amount) of the sodium imide salt is greater than or equal to about 0.2 wt % based on 100 wt % of the electrolyte for a rechargeable lithium battery.

The content (e.g., amount) of the sodium imide salt may be about 0.2 to about 1.0 wt % based on 100 wt % of the electrolyte for a rechargeable lithium battery.

The content (e.g., amount) of the sodium imide salt may be about 0.25 to about 0.3 wt % based on 100 wt % of the electrolyte for a rechargeable lithium battery.

The sodium imide salt may be NaFSI, NaTFSI, NaFTFSI (sodium (fluorosulfonyl) (trifluoromethanesulfonyl) imide), or a combination thereof.

The non-aqueous organic solvent may include a carbonate-based solvent, ester-based solvent, ether-based solvent, ketone-based solvent, alcohol-based solvent, or aprotic solvent.

The non-aqueous organic solvent may include a carbonate-based solvent in which cyclic carbonate and linear carbonate are mixed in a volume ratio of about 5:95 to about 50:50.

The cyclic carbonate may include ethylene carbonate (EC) and the linear carbonate may include ethylmethyl carbonate (EMC) and dimethyl carbonate (DMC).

The lithium salt may include one or two or more selected from LiPF₆, LiBF₄, LIDFOP, LIDFOB, LiPO₂F₂, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LIAlO₂, LiAlCl₄, LiN(CₓF₂ₓ₊₁SO₂)(C_{y}F_{2y+1}SO₂) (where x and y are natural numbers, for example integers from 1 to 20), LiCl, LiI, and LiB(C₂O₄)₂ (lithium bis(oxalato) borate: LiBOB).

A concentration of the lithium salt in the electrolyte for a rechargeable lithium battery may be about 1.0 M to about 2.0 M.

Embodiments provides a positive electrode including a positive electrode active material; a negative electrode including a negative electrode active material; and the electrolyte.

The positive electrode active material may include a lithium nickel-based composite oxide represented by Chemical Formula 1:

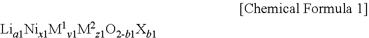

In Chemical Formula 1, 0.9≤a1≤1.2, 0.7≤x1≤1, 0≤y1≤0.2, 0≤z1≤0.2, 0.9≤x1+y1+z1≤1.1, and 0≤b1≤0.1; M¹ and M² may each independently be one or more elements selected from Al, B, Ba, Ca, Ce, Co, Cr, Cu, Fe, Mg, Mn, Mo, Nb, Si, Sr, Ti, V, W, and Zr; and X is one or more elements selected from F, P, and S.

The negative electrode active material may include at least one of graphite and a Si composite.

The Si composite may include a core including Si particles and amorphous carbon.

The core including the Si particles may include one or more of a Si—C composite, SiOₖ (0<k≤2), and a Si alloy.

The Si composite may be the Si—C composite, and the Si—C composite may include the core including the Si particles and the amorphous carbon.

Pores may be included in the central portion of the core.

A radius of the central portion corresponds to 30% to 50% of a radius of the Si—C composite, and an average particle diameter of the Si particles may be about 10 nm to about 200 nm.

The central portion does not include amorphous carbon, and the amorphous carbon may exist in the surface portion separate from the negative electrode active material.

The negative electrode active material may further include crystalline carbon.

An electrolyte for a rechargeable lithium battery according to embodiments may form a lithophilic film on the surface of the negative electrode and minimize or reduce precipitates at the interface between the negative electrode and the electrolyte by adding an appropriate or suitable amount of sodium imide salt. Accordingly, it is possible to realize a rechargeable lithium battery with improved rapid charging performance while suppressing deterioration of cycle-life characteristics and/or increase in resistance.

### BRIEF DESCRIPTION OF THE DRAWINGS

The drawing is a schematic view showing a rechargeable lithium battery according to embodiments of the present disclosure.

### DETAILED DESCRIPTION

Hereinafter, a rechargeable lithium battery according to embodiments of the present disclosure will be described in more detail with reference to the accompanying drawings. However, these embodiments are examples, the present disclosure is not limited thereto and the present disclosure is defined by the scope as claimed in claims.

Unless otherwise defined herein, particle diameter may be the average particle diameter. Also, by particle size is meant the average particle size (D50), which is the diameter of the particles in the particle size distribution that have a cumulative volume of 50 volume %. The average particle size may be measured by methods well known in the art, for example, by a particle size analyzer, or by a Transmission Electron Microscope photograph or a Scanning Electron Microscope photograph. Alternatively, measurements can be made with a device that uses dynamic light-scattering, and the data can be analyzed to count the number of particles for each particle size range, which can then be calculated to obtain an average particle diameter (D50) value. Alternatively, it can be measured using a laser diffraction method. When measuring by laser diffraction, more specifically, the particles to be measured are dispersed in a dispersing medium and introduced into a commercially available laser diffraction particle size measurement device (e.g., Microtrac MT 3000), irradiated with ultrasonic waves of approximately 28 kHz at a power of 60 W, and the average particle size (D50) based on 50% of the particle size distribution in the measurement device can be calculated.

Herein, as an example of the rechargeable lithium battery, a cylindrical rechargeable lithium battery will be described. The drawing schematically illustrates the structure of a rechargeable lithium battery according to embodiments. Referring to. the drawing, a rechargeable lithium battery 100 according to embodiments includes a battery cell including a positive electrode 114, a negative electrode 112 facing the positive electrode 114, a separator 113 between the positive electrode 114 and the negative electrode 112, and an electrolyte impregnating the positive electrode 114, the negative electrode 112, and the separator 113, a battery case 120 housing the battery cell, and a sealing member 140 sealing the battery case 120.

In embodiments of the present disclosure, an electrolyte for a rechargeable lithium battery includes a non-aqueous organic solvent, a lithium salt, and a sodium imide salt, wherein a content (e.g., amount) of the sodium imide salt is greater than or equal to about 0.2 wt % based on 100 wt % of the electrolyte for a rechargeable lithium battery.

If a sodium imide salt is not added as the additive of the electrolyte of the rechargeable lithium battery, cations (i.e., Lit) of the lithium salt are electrodeposited and form sharp lithium dendrite on the surface of the negative electrode, resultantly, deteriorating cycle-life and safety of the rechargeable lithium battery.

On the other hand, if a sodium imide salt is added as the additive of the electrolyte of the rechargeable lithium battery according to embodiments, the sodium imide salt and the lithium salt concurrently (e.g., simultaneously) exist inside the rechargeable lithium battery. Accordingly, cations (i.e., Na⁺ and Li⁺) of the two salts are concurrently (e.g., simultaneously) electrodeposited on the negative electrode surface, forming a lithophilic film with a substantially uniform thickness concurrently (e.g., simultaneously) including Na⁺ and Lit on the negative electrode surface; and a LiF inorganic film.

The lithophilic film with a substantially uniform thickness concurrently (e.g., simultaneously) including Na⁺ and Li⁺ may suppress or reduce the formation of sharp lithium dendrite and concurrently (e.g., simultaneously), minimize or reduce the precipitates on the interface of the negative electrode and the electrolyte. In some embodiments, the LiF inorganic film may lower a resistance increase rate of the negative electrode.

In some embodiments, the sodium imide salt, compared with the sodium phosphate salt, has an excellent or suitable effect of forming the lithophilic film. For example, the sodium imide salt includes an electron-donating group, compared with the sodium phosphate salt including the corresponding group, has an excellent or suitable effect of stabilizing phosphorus pentafluoride (PF) and/or the like.

However, if a content (e.g., amount) of the sodium imide salt may be about 0.2 wt % based on about 100 wt % of the electrolyte for the rechargeable lithium battery, the effect may be insignificant. Accordingly, the electrolyte for a rechargeable lithium battery according to embodiments includes a sodium imide salt at an appropriate or suitable concentration (i.e., about 0.2 wt % or more) as the additive, thereby realizing a rechargeable lithium battery with improved safety without deteriorating the rapid charging performance. On the other hand, based on about 100 wt % of the electrolyte for a rechargeable lithium battery, an upper limit of the content (e.g., amount) of the sodium imide salt is not particularly limited but may be about 1.0 wt % or less, about 0.5 wt % or less, or about 0.3 wt % or less.

For example, based on 100 wt % of the electrolyte for a rechargeable lithium battery, the content (e.g., amount) of the sodium imide salt may be about 0.2 to about 1.0 wt %, or about 0.25 to about 0.3 wt %. If the example range is satisfied, the lithophilic film is formed at an appropriate or suitable level on the negative electrode surface, and the precipitates may be minimized or reduced on the interface of the negative electrode and the electrolyte. Accordingly, a rechargeable lithium battery with improved rapid charging performance, while suppressing the cycle-life characteristic deterioration and/or the resistance increase, may be realized.

The sodium imide salt may be NaFSI (sodium bis (fluorosulfonyl) imide, sodium bis (fluorosulfonyl) imide), NaTFSI (sodium bis (trifluorosulfonyl) imide, sodium bis (trifluorosulfonyl) imide)), NaFTFSI (sodium (fluorosulfonyl) (trifluoromethanesulfonyl) imide), or a combination thereof. For example, the sodium imide salt may be any one of the two compounds.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, t-butyl acetate, methylpropionate, ethylpropionate, propylpropionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone and/or the like. The alcohol-based solvent may include ethyl alcohol, isopropyl alcohol, and/or the like, and examples of the aprotic solvent include nitriles such as R—CN (wherein R is a C₂ to C₂₀ linear, branched, or cyclic hydrocarbon group, a double bond, an aromatic ring, or an ether bond), amides such as dimethylformamide, dioxolanes such as 1,3-dioxolane, sulfolanes, and/or the like.

The non-aqueous organic solvent may be utilized alone or in a mixture. If the organic solvent is utilized in a mixture, their mixing ratio may be controlled or selected in accordance with a desirable battery performance.

The carbonate-based solvent is prepared by mixing a cyclic carbonate and a linear carbonate. The cyclic carbonate and linear carbonate are mixed together in a volume ratio of about 5:95 to about 50:50. If the mixture is utilized as an electrolyte, it may have enhanced performance.

For example, ethylene carbonate (EC) may be utilized as the cyclic carbonate, and ethylmethyl carbonate (EMC) and dimethyl carbonate (DMC) may be utilized as the linear carbonate.

For example, the non-aqueous organic solvent may include a carbonate-based solvent in which ethylene carbonate (EC), ethylmethyl carbonate (EMC), and dimethyl carbonate (DMC) are mixed. For example, the carbonate-based solvent in which ethylene carbonate (EC), ethylmethyl carbonate (EMC), and dimethyl carbonate (DMC) are mixed is mixed in a volume ratio of EC:EMC:DMC=about 1:0.5:5 to about 5:3:10, which may improve performance of the electrolyte.

The non-aqueous organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based solvent may be an aromatic hydrocarbon-based compound represented by Chemical Formula 3.

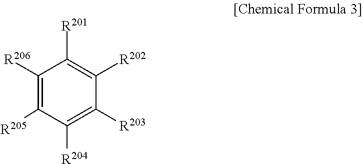

In Chemical Formula 3, R²⁰¹ to R²⁰⁶ may each independently be the same or different and are selected from hydrogen, a halogen, a C₁ to C₁₀ alkyl group, a haloalkyl group, and a combination thereof.

Specific examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate, vinyl ethylene carbonate, or an ethylene-based carbonate-based compound of Chemical Formula 4 to improve cycle-life of a battery as a cycle life-enhancing additive.

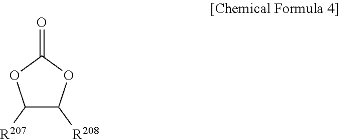

In Chemical Formula 4, R²⁰⁷ and R²⁰⁸ may each independently be the same or different and are selected from hydrogen, a halogen, a cyano group (CN), a nitro group (NO₂), or a C₁ to C₅ fluoroalkyl group, provided that at least one selected from R²⁰⁷ and R²⁰⁸ is a halogen, a cyano group (CN), a nitro group (NO₂), or a C₁ to C₅ fluoroalkyl group, and R²⁰⁷ and R²⁰⁸ are not concurrently (e.g., simultaneously) hydrogen.

Examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate or fluoroethylene carbonate. The amount of the additive for improving cycle-life may be utilized within an appropriate or suitable range.

The lithium salt is dissolved in a non-aqueous organic solvent, supplies a battery with lithium ions, basically operates the rechargeable lithium battery, and improves transportation of the lithium ions between positive and negative electrodes. Examples of the lithium salt include one or more selected from LiPF₆, LiBF₄, LiDFOP, LIDFOB, LiPO₂F₂, LiSbF₆, LiASF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAIO₂, LiAlCl₄, LiN(CₓF₂ₓ₊₁SO₂)(C_{y}F_{2y+1}SO₂), (where x and y are natural numbers, for example an integer of 1 to 20), LiCl, LiI and LiB(C₂O₄)₂ (lithium bis(oxalato) borate; LiBOB). The lithium salt may be utilized in a concentration in a range of about 0.1 M to about 2.0 M. If the lithium salt is included at the above concentration range, an electrolyte may have excellent or suitable performance and lithium ion mobility due to optimal or suitable electrolyte conductivity and viscosity.

Another embodiment provides a rechargeable lithium battery including a positive electrode including a positive electrode active material; a negative electrode including a negative electrode active material; and the aforementioned electrolyte.

The positive electrode includes a positive electrode current collector and a positive electrode active material layer on the positive electrode current collector, and the positive electrode active material layer includes a positive electrode active material.

The positive electrode active material may include lithiated intercalation compounds that reversibly intercalate and deintercalate lithium ions.

For example, at least one composite oxide of lithium and a metal of cobalt, manganese, nickel, or a combination thereof may be utilized.

The composite oxide having a coating layer on the surface thereof may be utilized, or a mixture of the composite oxide and the composite oxide having a coating layer may be utilized. The coating layer may include a coating element compound of an oxide or hydroxide of a coating element, oxyhydroxide of a coating element, oxycarbonate of a coating element, or hydroxycarbonate of a coating element. The compound for the coating layer may be either amorphous or crystalline. The coating element included in the coating layer may be Mg, Al, Co, K, Na, Ca, Si, Ti, V, Sn, Ge, Ga, B, As, Zr, or a mixture thereof. The coating process may include any processes as long as it does not cause any side effects on the properties of the positive electrode active material (e.g., spray coating, dipping), which is suitable to persons having ordinary skill in this art, so a detailed description thereof is omitted.

For example, the positive electrode active material may include a lithium nickel-based composite oxide represented by Chemical Formula 1:

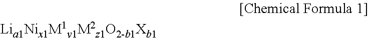

In Chemical Formula 1, 0.9≤a1≤1.2, 0.7≤x1≤1, 0≤y1≤0.2, 0≤z1≤0.2, 0.9≤x1+y1+z1≤1.1, and 0≤b1≤0.1; M¹ and M² may each independently be one or more elements selected from Al, B, Ba, Ca, Ce, Co, Cr, Cu, Fe, Mg, Mn, Mo, Nb, Si, Sr, Ti, V, W, and Zr; and X is one or more elements selected from F, P, and S.

In Chemical Formula 1, 0.75≤x1≤1, 0≤y1≤0.18, and 0≤z1≤0.18; 0.85≤x1≤1, 0≤y1≤0.15, and 0≤z1≤0.15; or 0.9≤x1≤1, 0≤y1≤0.1, and 0≤z1≤0.1.

For example, the positive electrode active material may include a lithium nickel-based composite oxide represented by Chemical Formula 2. The compound represented by Chemical Formula 2 may be referred to as a lithium nickel cobalt-based composite oxide:

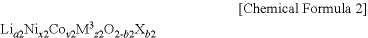

In Chemical Formula 2, 0.9≤a2≤1.8, 0.7≤x2<1, 0<y2≤0.2, 0≤z2≤0.2, 0.9≤x2+y2+z2≤1.1, and 0≤b2≤0.1, M³ is one or more elements selected from Al, B, Ba, Ca, Ce, Cr, Fe, Mg, Mn, Mo, Nb, Si, Sr, Ti, V, W, and Zr, and X is one or more elements selected from F, P, and S.

In Chemical Formula 2, 0.75≤x2≤0.99, 0≤y2≤0.15, and 0≤z2≤0.15; 0.85≤x2≤0.99, 0.01≤y2≤0.15, and 0.01≤z2≤0.15; or 0.9≤x2≤0.99, 0.01≤y2≤0.1, and 0.01≤z2≤0.1.

For example, the positive electrode active material may include a lithium nickel-based composite oxide represented by Chemical Formula 3. The compound represented by Chemical Formula 3 may be referred to as lithium nickel-cobalt-aluminum oxide or lithium nickel-cobalt-manganese oxide.

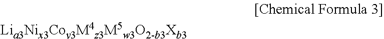

In Chemical Formula 3, 0.9≤a3≤1.8, 0.7≤x3≤0.98, 0.01≤y3≤0.19, 0.01≤z3≤0.19, 0≤w3≤0.19, 0.9≤x3+y3+z3+w3≤1.1, and 0≤b3≤0.1, M⁴ is one or more elements selected from Al and Mn, M⁵ is one or more elements selected from B, Ba, Ca, Ce, Cr, Fe, Mg, Mo, Nb, Si, Sr, Ti, V, W, and Zr, and X is one or more elements selected from F, P, and S.

In Chemical Formula 3, 0.75≤x3≤0.98, 0≤y3≤0.16, and 0≤z3≤0.16; 0.85≤x3≤0.98, 0.01≤y3≤0.14, 0.01≤z3≤0.14, and 0≤w3≤0.14; or 0.9≤x3≤0.98, 0.01≤y3≤0.09, 0.01≤z3≤0.09, and 0≤w3≤0.09.

For example, the positive electrode active material may include a lithium nickel-based composite oxide represented by Chemical Formula 4. The compound represented by Chemical Formula 4 may be referred to as a cobalt-free lithium nickel-manganese oxide.

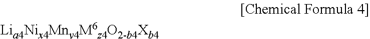

In Chemical Formula 4, 0.9≤a2≤1.8, 0.7≤x4<1, 0<y4≤0.2, 0≤z4≤0.2, 0.9≤x4+y4+z4≤1.1, and 0≤b4≤0.1 M⁶ is one or more elements selected from Al, B, Ba, Ca, Ce, Cr, Fe, Mg, Mo, Nb, Si, Sr, Ti, V, W, and Zr, and X is one or more elements selected from F, P, and S.

In the positive electrode active material according to embodiments, the first positive electrode active material may be included in an amount of about 50 wt % to about 90 wt %, and the second positive electrode active material is included in an amount of about 10 wt % to about 50 wt %, based on the total amount of the first and second positive electrode active materials. The first positive electrode active material may be included in, for example, about 60 wt % to about 90 wt %, or about 70 wt % to about 90 wt % and the second positive electrode active material may be included in about 10 wt % to about 40 wt %, or about 10 wt % to about 30 wt %. If the content (e.g., amount) ratio of the first positive electrode active material and the second positive electrode active material is as above, the positive electrode active material including the same may realize high capacity, improve mixture density, and exhibit high energy density.

A content (e.g., amount) of the positive electrode active material may be about 50 wt % to about 99 wt %, about 60 wt % to about 99 wt %, about 70 wt % to about 99 wt %, about 80 wt % to about 99 wt %, or about 90 wt % to about 99 wt % based on a total weight of the positive electrode active material layer.

In embodiments of the present disclosure, the positive electrode active material layer may optionally include a conductive material and a binder. In this case, each content (e.g., amount) of the conductive material and the binder may be about 1.0 wt % to about 5.0 wt %, based on a total weight of the positive electrode active material layer.

The conductive material is utilized to impart conductivity to the negative electrode, and any electrically conductive material may be utilized as a conductive material unless it causes a chemical change in a battery. Examples of the conductive material may include a carbon-based material such as natural graphite, artificial graphite, carbon black, acetylene black, ketjen black, carbon fiber, and/or the like; a metal-based material of a metal powder or a metal fiber including copper, nickel, aluminum, silver, and/or the like; a conductive polymer such as a polyphenylene derivative; or a mixture thereof.

The binder improves binding properties of positive electrode active material particles with one another and with a current collector and examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but are not limited thereto.

Al may be utilized as the positive electrode current collector, but is not limited thereto.

The negative electrode includes a negative electrode current collector and a negative electrode active material layer including the negative electrode active material on the negative electrode current collector.

The negative electrode active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions includes carbon materials. The carbon material may be any generally-utilized carbon-based negative electrode active material in a rechargeable lithium battery. Examples of the carbon material include crystalline carbon, amorphous carbon, and a combination thereof. The crystalline carbon may be non-shaped, or sheet, flake, spherical, or fiber shaped natural graphite or artificial graphite. The amorphous carbon may be a soft carbon, a hard carbon, a mesophase pitch carbonized product, fired coke, and/or the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping and dedoping lithium may include Si, SiOₓ (0<x<2), a Si-Q alloy (wherein Q is selected from an alkali metal, an alkaline-earth metal, a Group 13 element, a Group 14 element, a Group 15 element, a Group 16 element, a transition metal, a rare earth element, and a combination thereof, and not Si), Sn, SnO₂, a Sn—R alloy (wherein R is an alkali metal, an alkaline-earth metal, a Group 13 element, a Group 14 element, a Group 15 element, a Group 16 element, a transition element, a rare earth element, or a combination thereof, and not Sn), and/or the like. At least one of them may be mixed with SiO₂.

The elements Q and R may be selected from Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The transition metal oxide may be a vanadium oxide, a lithium vanadium oxide, and/or the like.

In embodiments, the negative electrode active material may include at least one of graphite and a Si composite.

The Si composite may include a core including Si particles and amorphous carbon, for example, the Si particles may include at least one of Si composite, SiOₓ (0<x≤2), or an Si alloy.

For example, the Si composite may be the Si—C composite that may include the core including the Si particles and the amorphous carbon.

The central portion of the core may include pores, and the radius of the central portion may correspond to about 30% to about 50% of the radius of the Si—C composite.

The Si particles may have an average particle diameter of about 10 nm to about 200 nm.

As utilized herein, the average particle diameter may be a particle size (D50) at a volume ratio of 50% in a cumulative size-distribution curve.

If the average particle diameter of the Si particle is within the above range, volume expansion occurring during charging and discharging may be suppressed or reduced, and a disconnection of a conductive path due to particle crushing during charging and discharging may be prevented or reduced.

The Si particle may be included in an amount of about 1 wt % to about 60 wt %, for example, about 3 wt % to about 60 wt %, based on a total weight of the Si—C composite.

The central portion may not include (e.g., may exclude) amorphous carbon, but the amorphous carbon may be present only on the surface portion of the negative active material.

Herein, the surface portion indicates a region from the central portion of the negative active material to the outermost surface of the negative active material.

In some embodiments, the Si particles are substantially uniformly included over the negative active material, that is, present at a substantially uniform concentration in the central portion and the surface portion thereof.

The amorphous carbon may be soft carbon, hard carbon, mesophase pitch carbonized product, calcined coke, or a combination thereof.

The negative electrode active material may further include crystalline carbon.

If the negative electrode active material includes a Si—C composite and crystalline carbon together, the Si—C composite and crystalline carbon may be included in the form of a mixture, and in this case, the Si—C composite and crystalline carbon may be included in a weight ratio of about 1:99 to about 50:50. For example, the Si—C composite and crystalline carbon may be included in a weight ratio of 3:97 to 20:80 or 5:95 to 20:80.

The crystalline carbon may be for example graphite, and for example natural graphite, artificial graphite, or a mixture thereof.

The crystalline carbon may have an average particle diameter of about 5 μm to about 30 μm.

The amorphous carbon precursor may include a coal-based pitch, mesophase pitch, petroleum-based pitch, coal-based oil, petroleum-based heavy oil, or a polymer resin such as a phenol resin, a furan resin, or a polyimide resin.

In the negative electrode active material layer, the negative electrode active material may be included in an amount of about 95 wt % to about 99 wt % based on a total weight of the negative electrode active material layer.

In embodiments, the negative electrode active material layer may include a binder, and optionally a conductive material. In the negative electrode active material layer, the amount of the binder may be about 1 wt % to about 5 wt % based on a total weight of the negative electrode active material layer. If it further includes the conductive material, it may include about 90 wt % to about 98 wt % of the negative electrode active material, about 1 wt % to about 5 wt % of the binder, and about 1 wt % to about 5 wt % of the conductive material.

The binder improves binding properties of negative electrode active material particles with one another and with a current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylene copolymer, polyethyleneoxide, polyvinylpyrrolidone, polyepichlorohydrine, polyphosphazene, polyacrylonitrile, polystyrene, an ethylene propylenediene copolymer, polyvinylpyridine, chlorosulfonatedpolyethylene, latex, a polyester resin, an acrylic resin, a phenolic resin, an epoxy resin, polyvinylalcohol, and a combination thereof.

If the water-soluble binder is utilized as the negative electrode binder, a cellulose-based compound may be further utilized to provide viscosity as a thickener. The cellulose-based compound includes one or more of carboxylmethyl cellulose, hydroxypropylmethyl cellulose, methyl cellulose, or alkali metal salts thereof. The alkali metal may be Na, K, or Li. Such a thickener may be included in an amount of about 0.1 to about 3 parts by weight based on 100 parts by weight of the negative electrode active material.

The conductive material is included to provide electrode conductivity and any electrically conductive material may be utilized as a conductive material unless it causes a chemical change. Examples thereof may be a carbon-based material such as natural graphite, artificial graphite, carbon black, acetylene black, ketjen black, carbon fiber and/or the like; a metal-based material such as a metal powder or a metal fiber and/or the like of copper, nickel, aluminum, silver, and/or the like; a conductive polymer such as a polyphenylene derivative and/or the like, or a mixture thereof.

The negative electrode current collector may be selected from a copper foil, a nickel foil, a stainless steel foil, a titanium foil, a nickel foam, a copper foam, a polymer substrate coated with a conductive metal, and a combination thereof.

The rechargeable lithium battery may further include a separator between the negative electrode and the positive electrode, depending on a type or kind of the rechargeable lithium battery. These separators are porous substrates; or it may be a composite porous substrate.

The porous substrate may be a substrate including pores, and lithium ions may move through the pores. The porous substrate may be for example may include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The composite porous substrate may have a form including a porous substrate and a functional layer on the porous substrate. The functional layer may be, for example, at least one of a heat-resistant layer and an adhesive layer from the viewpoint of enabling additional function. For example, the heat-resistant layer may include a heat-resistant resin and optionally a filler.

In some embodiments, the adhesive layer may include an adhesive resin and optionally a filler.

The filler may be an organic filler or an inorganic filler.

Referring to the drawing, a rechargeable lithium battery 100 according to embodiments includes a battery cell including a negative electrode 112, a positive electrode 114 facing the negative electrode 112, a separator 113 interposed between the negative electrode 112 and the positive electrode 114, and an electrolyte impregnating the negative electrode 112, the positive electrode 114, and the separator 113, a battery case 120 housing the battery cell, and a sealing member 140 sealing the battery case 120.

Hereinafter, examples of the present disclosure and comparative examples are described. These examples, however, are not in any sense to be interpreted as limiting the scope of the present disclosure.

### Preparation of Electrolyte for Rechargeable Lithium Battery

### Preparation Example 1

As a non-aqueous organic solvent, a carbonate based solvent prepared by mixing ethylene carbonate (EC): ethylmethyl carbonate (EMC): dimethyl carbonate (DMC)=20:10:70 in a volume ratio was utilized.

The non-aqueous organic solvent was mixed with a 1.5 M lithium salt (LiPF₆), and 0.2 wt % of a sodium imide salt (NaFSI) as an additive was added thereto, finally obtaining an electrolyte for a rechargeable lithium battery.

Herein, a content (e.g., amount) (wt %) of the sodium imide salt refers to a content (e.g., amount) of the sodium imide salt (wt %) based on 100 wt % of the electrolyte for a rechargeable lithium battery. This will be the same as.

### Preparation Example 2

An electrolyte for a rechargeable lithium battery was prepared in substantially the same manner as in Preparation Example 1 except that 0.25 wt % of a sodium imide salt (NaFSI) as the additive was utilized.

### Preparation Example 3

An electrolyte for a rechargeable lithium battery was prepared in substantially the same manner as in Preparation Example 1 except that 0.3 wt % of a sodium imide salt (NaFSI) as the additive was utilized.

### Preparation Example 4

An electrolyte for a rechargeable lithium battery was prepared in substantially the same manner as in Preparation Example 1 except that 0.5 wt % of a sodium imide salt (NaFSI) as the additive was utilized.

### Preparation Example 5

An electrolyte for a rechargeable lithium battery was prepared in substantially the same manner as in Preparation Example 1 except that 1.0 wt % of a sodium imide salt (NaFSI) as the additive was utilized.

### Preparation Example 6

An electrolyte for a rechargeable lithium battery was prepared in substantially the same manner as in Preparation Example 1 except that 0.25 wt % of a sodium imide salt (NaTFSI) as the additive was utilized.

### Preparation Comparative Example 1

An electrolyte for a rechargeable lithium battery was prepared in substantially the same manner as in Preparation Example 1 except that the additive was not added at all.

### Preparation Comparative Example 2

An electrolyte for a rechargeable lithium battery was prepared in substantially the same manner as in Preparation Example 1 except that 0.2 wt % of a sodium phosphate salt (NaPF₆) as the additive was utilized.

### Preparation Comparative Example 3

An electrolyte for a rechargeable lithium battery was prepared in substantially the same manner as in Preparation Example 1 except that 0.15 wt % of a sodium imide salt (NaFSI) as the additive was utilized.

### Preparation Comparative Example 4

An electrolyte for a rechargeable lithium battery was prepared in substantially the same manner as in Preparation Example 1 except that 1.15 M lithium salt (LiPF₆) was utilized instead of the 1.5 M lithium salt (LiPF₆), and about 8.5 wt % of a 0.5 M sodium imide salt (NaFSI) was utilized instead of 0.02 wt % of the sodium imide salt (NaFSI) as the additive.

### Manufacture of Rechargeable Lithium Battery Cell

### Example 1

### (1) Manufacture of Positive Electrode

LiNi_{0.88}Co_{0.07}Al_{0.0502} as a positive electrode active material, polyvinylidene fluoride as a binder, and ketjen black as a conductive material were mixed respectively in a weight ratio of 97:2:1, and then, dispersed in N-methyl pyrrolidone to prepare positive electrode active material slurry.

The positive electrode active material slurry was coated on a 14 μm-thick Al foil, dried at 110° C., and pressed to manufacture a positive electrode.

### (2-1) Manufacture of Negative Electrode (if Manufacturing Full-Cell)

A mixture of artificial graphite and Si—C composite in a weight ratio of 93:7 was prepared as a negative electrode active material, and the negative electrode active material, a styrene-butadiene rubber binder, and carboxylmethyl cellulose in a weight ratio of 97:1:2 were dispersed in distilled water to prepare negative electrode active material slurry.

The Si—C composite included a core including artificial graphite and silicon particles and coal pitch coated on the surface of the core.

The negative electrode active material slurry was coated on a 10 μm-thick Cu foil, dried at 100° C., and pressed to manufacture a negative electrode.

### (2-2) Manufacture of Negative Electrode (if Manufacturing Half-Cell)

As a negative electrode, which is a counter electrode, 10 μm-thick Li metal was utilized.

### (3) Manufacture of Rechargeable Lithium Battery Cell

The manufactured positive and negative electrodes and a polyethylene separator having a thickness of 25 μm were assembled to manufacture an electrode assembly, and the electrolyte for a rechargeable lithium battery of Preparation Example 1 was injected to prepare a rechargeable lithium battery cell.

### Example 2

A rechargeable lithium battery cell was manufactured in substantially the same as in Example 1 except that the electrolyte for a rechargeable lithium battery of Preparation Example 2 was injected.

### Example 3

A rechargeable lithium battery cell was manufactured in substantially the same as in Example 1 except that the electrolyte for a rechargeable lithium battery of Preparation Example 3 was injected.

### Example 4

A rechargeable lithium battery cell was manufactured in substantially the same as in Example 1 except that the electrolyte for a rechargeable lithium battery of Preparation Example 4 was injected.

### Example 5

A rechargeable lithium battery cell was manufactured in substantially the same as in Example 1 except that the electrolyte for a rechargeable lithium battery of Preparation Example 5 was injected.

### Example 5

A rechargeable lithium battery cell was manufactured in substantially the same as in Example 1 except that the electrolyte for a rechargeable lithium battery of Preparation Example 6 was injected.

### Comparative Example 1

A rechargeable lithium battery cell was manufactured in substantially the same as in Example 1 except that the electrolyte for a rechargeable lithium battery of Preparation Comparative Example 1 was injected.

### Comparative Example 2

A rechargeable lithium battery cell was manufactured in substantially the same as in Example 1 except that the electrolyte for a rechargeable lithium battery of Preparation Comparative Example 2 was injected.

### Comparative Example 3

A rechargeable lithium battery cell was manufactured in substantially the same as in Example 1 except that the electrolyte for a rechargeable lithium battery of Preparation Comparative Example 3 was injected.

### Comparative Example 4

A rechargeable lithium battery cell was manufactured in substantially the same as in Example 1 except that the electrolyte for a rechargeable lithium battery of Preparation Comparative Example 4 was injected.

### Evaluation 1: Evaluation of Precipitates at the Interface Between the Negative Electrode and Electrolyte

The rechargeable lithium battery half-cells according to Examples 1 to 6 and Comparative Examples 1 to 4 were each CC-charged at 1 C to SOC 80% and discharged at 0.1 C and then, measured with respect to a precipitation amount of lithium dendrite according to Equation 1, and the results are shown in Table 1:

$$Lithium dendrite precipitation \\ amount ( \% ) = 100 * ( lithium dendrite amount \\ after discharging under the above conditions ) / ( lithium \\ charge amount at SOC 100 \% ( full charge ) ) \qquad [ Equation 1 ]$$

TABLE 1

| | Lithium dendrite |
|---|---|
| | precipitation amount [%] |
| Comparative Example 1 | 1.53 |
| Comparative Example 2 | 1.43 |
| Comparative Example 3 | 1.43 |
| Comparative Example 4 | 2.05 |
| Example 1 | 1.21 |
| Example 2 | 1.18 |
| Example 3 | 1.20 |
| Example 4 | 1.21 |
| Example 5 | 1.21 |
| Example 6 | 1.30 |

Referring to Table 1, Examples 1 to 6, compared with Comparative Examples 1, 3, and 4, were each suppressed or reduced from precipitation of lithium dendrite on the surface of a negative electrode and an electrolyte, which was helpful for rapid charging.

Evaluation 2: Evaluation of DC Resistance Increase Rate during Rapid Charging

The rechargeable lithium battery full cells of Examples 1 to 6 and Comparative Examples 1 to 4 were evaluated under the following conditions, and the results are shown in Table 2.

The cells were each constant current-charged to a voltage of 4.2 V at a current rate of 2.0 C to 3.0 C at 25° C. Subsequently, the cells were each constant current-discharged to a voltage of 2.8 V at a rate of 0.5 C, wherein this charge and discharge cycle was 300 times repeated (300th cycles). In all the charge and discharge cycles, a pause of 10 minutes was set after every charge/discharge cycle. After the 300 charge and discharge cycles, the cells were measured with respect to resistance, which was utilized to calculate a DC-IR increase rate (%) according to Equation 1.

$$DC - IR increase rate during rapid charging = DC - IR ( 300 charge / discharge cycles ) / DCIR ( 0 d . ) \times 100 \% \qquad [ Equation 1 ]$$

In Equation 1, DC-IR (300 charge and discharge cycles) represents DCIR after 60 charge and discharge cycles at 25° C., and DC-IR (0d.) represents DC-IR right before the 300 charge and discharge cycles.

TABLE 2

| | Resistance increase rate |
|---|---|
| | after rapid charging |
| | 300 cycles [%, @25° C.] |
| Comparative Example 1 | 12.9 |
| Comparative Example 2 | 10.2 |
| Comparative Example 3 | 9.95 |
| Comparative Example 4 | 25.0 |
| Example 1 | 9.05 |
| Example 2 | 4.00 |
| Example 3 | 4.13 |
| Example 4 | 4.20 |
| Example 5 | 4.20 |
| Example 6 | 6.30 |

Referring to Table 2, Examples 1 to 6, compared with Comparative Examples 1 to 4, were suppressed or reduced from resistance increase during the rapid charging and thus exhibited improved rapid charging cycle life.

### Evaluation 3: Evaluation of Rapid Charging Time

The rechargeable lithium battery cells of Examples 1 to 6 and Comparative Examples 1 to 4 were evaluated under the following conditions, and the results are shown in Table 3.

Time to reach SOC 80% or SOC 100% (full charge), if CC-CV charged (4.2 V) at a current of 1 C at 25° C., was measured.

TABLE 3

| | Time to reach 80% | Time to reach 100% |
|---|---|---|
| | rapid charging SOC | rapid charging SOC |
| | min, @25° C.] | min, @25° C.] |
| Comparative Example 1 | 40.1 | 57.0 |
| Comparative Example 2 | 40.3 | 57.3 |
| Comparative Example 3 | 41.0 | 56.9 |
| Comparative Example 4 | 49.0 | 61.0 |
| Example 1 | 38.0 | 56. |
| Example 2 | 36.5 | 54.3 |
| Example 3 | 37.0 | 55.0 |
| Example 4 | 37.1 | 56.0 |
| Example 5 | 38.0 | 56.5 |
| Example 6 | 36.5 | 56.0 |

Referring to Table 3, Examples 1 to 6, compared with Comparative Examples 1 to 4, were suppressed or reduced from resistance increase during the rapid charging and also, exhibited improved rapid charging time.

The terminology utilized herein is utilized to describe embodiments only, and is not intended to limit the present disclosure. The singular expression includes the plural expression unless the context clearly dictates otherwise.

As utilized herein, “combination thereof” refers to a mixture, laminate, composite, copolymer, alloy, blend, reaction product, and/or the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout, and duplicative descriptions thereof may not be provided the specification. It will be understood that if an element such as a layer, film, region, or substrate is referred to as being “on” another element, it can be directly on the other element or intervening elements may also be present. In contrast, if an element is referred to as being “directly on” another element, there are no intervening elements present.

In some embodiments, “layer” herein includes not only a shape formed on the whole surface if viewed from a plan view, but also a shape formed on a partial surface.

Herein, “or” is not to be construed as an exclusive meaning, for example, “A or B” is construed to include A, B, A+B, and/or the like.

As used herein, the term “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

As used herein, the terms “use,” “using,” and “used” may be considered synonymous with the terms “utilize,” “utilizing,” and “utilized,” respectively.

The use of “may” if describing embodiments of the present disclosure refers to “one or more embodiments of the present disclosure.”

As used herein, the singular forms “a”, “an” and “the” are intended to include the plural forms as well, unless the context clearly indicates otherwise.

In the present disclosure, if particles are spherical, “size” or “diameter” indicates a particle diameter or an average particle diameter, and if the particles are non-spherical, the “size” or “diameter” indicates a major axis length or an average major axis length. That is, if particles are spherical, “diameter” indicates a particle diameter, and if the particles are non-spherical, the “diameter” indicates a major axis length. The size or diameter of the particles may be measured utilizing a scanning electron microscope or a particle size analyzer. As the particle size analyzer, for example, HORIBA, LA-950 laser particle size analyzer, may be utilized. If the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle if the total number of particles is 100% in the distribution curve accumulated in the order of the smallest particle size to the largest particle size.

As used herein, expressions such as “at least one of”, “one of”, and “selected from”, if preceding a list of elements, modify the entire list of elements and do not modify the individual elements of the list. For example, “at least one of a, b or c”, “at least one selected from a, b and c”, etc., may indicate only a, only b, only c, both (e.g., simultaneously) a and b, both (e.g., simultaneously) a and c, both (e.g., simultaneously) b and c, all of a, b, and c, or variations thereof.

The vehicle, a battery management system (BMS) device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the drawings, it will be understood by those of ordinary skill in the art that one or more suitable changes in form and details may be made therein without departing from the spirit and scope of the disclosure as defined by the following claims and equivalents thereof.

### DESCRIPTION OF SYMBOLS

100: rechargeable lithium battery
112: negative electrode
113: separator
114: positive electrode
120: battery case
140: sealing member

What is claimed is:

1. An electrolyte for a rechargeable lithium battery, the electrolyte comprising:
a non-aqueous organic solvent;
a lithium salt; and
a sodium imide salt,
wherein an amount of the sodium imide salt is greater than or equal to about 0.2 wt % based on 100 wt % of the electrolyte.

2. The electrolyte as claimed in claim 1, wherein
the amount of the sodium imide salt is about 0.2 to about 1.0 wt % based on 100 wt % of the electrolyte.

3. The electrolyte as claimed in claim 2, wherein
the amount of the sodium imide salt is about 0.25 to about 0.3 wt % based on 100 wt % of the electrolyte.

4. The electrolyte as claimed in claim 1, wherein
the sodium imide salt is NaFSI, NaTFSI, NaFTFSI (sodium (fluorosulfonyl) (trifluoromethanesulfonyl) imide), or a combination thereof.

5. The electrolyte as claimed in claim 1, wherein
the non-aqueous organic solvent comprises a carbonate-based solvent, an ester-based solvent, an ether-based solvent, a ketone-based solvent, an alcohol-based solvent, or an aprotic solvent.

6. The electrolyte as claimed in claim 5, wherein
the non-aqueous organic solvent comprises cyclic carbonate and linear carbonate in a volume ratio of about 5:95 to about 50:50.

7. The electrolyte as claimed in claim 6, wherein
the cyclic carbonate comprises ethylene carbonate (EC),
the linear carbonate comprises ethylmethyl carbonate (EMC) and dimethyl carbonate (DMC).

8. The electrolyte as claimed in claim 1, wherein
the lithium salt include one or two or more selected from LiPF₆, LiBF₄, LiDFOP, LIDFOB, LiPO₂F₂, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LiAIO₂, LiAlCl₄, LiN(CₓF₂ₓ₊₁SO₂)(C_{y}F_{2y+1}SO₂) (where x and y are integers from 1 to 20), LiCl, LiI, and LiB(C₂O₄)₂ (lithium bis(oxalato) borate: LiBOB).

9. The electrolyte as claimed in claim 8, wherein
a concentration of the lithium salt in the electrolyte for a rechargeable lithium battery is about 1.0 M to about 2.0 M.

10. A rechargeable lithium battery, comprising
a positive electrode comprising a positive electrode active material;
a negative electrode comprising a negative electrode active material; and
the electrolyte as claimed in claim 1.

11. The rechargeable lithium battery as claimed in claim 10, wherein
the positive electrode active material comprises a lithium nickel-based composite oxide represented by Chemical Formula 1: 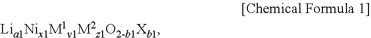
wherein, in Chemical Formula 1:
0.9≤a1≤1.2, 0.7≤x1≤1, 0≤y1≤0.2, 0≤z1≤0.2, 0.9≤x1+y1+z1≤1.1, and 0≤b1≤0.1;
M¹ and M² are each independently one or more elements selected from Al, B, Ba, Ca, Ce, Co, Cr, Cu, Fe, Mg, Mn, Mo, Nb, Si, Sr, Ti, V, W, and Zr; and
X is one or more elements selected from F, P, and S.

12. The rechargeable lithium battery as claimed in claim 10, wherein
the negative electrode active material comprises at least one selected from graphite and a Si composite.

13. The rechargeable lithium battery as claimed in claim 12, wherein
the Si composite comprises a core comprising Si particles and amorphous carbon.

14. The rechargeable lithium battery as claimed in claim 13, wherein
the core comprises one or more selected from a Si—C composite, SiOₖ, and a Si alloy, and
wherein 0<k≤2.

15. The rechargeable lithium battery as claimed in claim 14, wherein the Si composite is the Si—C composite,
wherein the Si—C composite comprises the core comprising the Si particles and the amorphous carbon.

16. The rechargeable lithium battery as claimed in claim 15, wherein pores are in the central portion of the core.

17. The rechargeable lithium battery as claimed in claim 16, wherein
a radius of the central portion corresponds to 30% to 50% of a total radius of the Si—C composite, and
an average particle diameter of the Si particles is about 10 nm to about 200 nm.

18. The rechargeable lithium battery as claimed in claim 16, wherein
the central portion does is amorphous carbon free, and the amorphous carbon exists in the surface portion separate from other portions of the negative electrode active material.

19. The rechargeable lithium battery as claimed in claim 15, wherein
the negative electrode active material further comprises crystalline carbon.
